(19) United States
(12) Patent Application Publication
(10) Pub. No.: US 2026/0330225 A1
(43) Pub. Date: Oct. 22, 2026

(54) HYBRID LANGUAGE MODEL COMPRESSION THROUGH GROUP-AWARE PRUNING

(71) Applicant: NVIDIA Corporation, Santa Clara, CA (US)

(72) Inventors: Ali Taghibakhshi, Chicago, IL (US); Yashaswi Karnati, Chicago, IL (US); Sharath Turuvekere Sreenivas, Chicago, IL (US); Marcin Chochowski, Chicago, IL (US); Saurav Muralidharan, San Jose, CA (US); Raviraj Joshi, Chicago, IL (US); Daniel Korzekwa, Chicago, IL (US); Mostofa Patwary, Chicago, IL (US); Mohammad Shoeybi, Chicago, IL (US); Jan Kautz, Lexington, MA (US); Bryan Catanzaro, Chicago, IL (US); Ashwath Aithal, Chicago, IL (US); Nima Tajbakhsh, Chicago, IL (US); Pavlo Molchanov, Mountain View, CA (US)

(21) Appl. No.: 19/322,454

(22) Filed: Sep. 8, 2025

Related U.S. Application Data
(60) Provisional application No. 63/786,832, filed on Apr. 10, 2025.

(51) Int. Cl. G06N 3/082; G06N 3/048; G06N 3/0495; G06N 3/096

(52) U.S. Cl. CPC G06N 3/082; G06N 3/048; G06N 3/0495; G06N 3/096

(57) ABSTRACT

Recent advances in language modeling have led to the development of hybrid architectures that combine Transformer layers with State Space Models (SSMs). These hybrid models leverage the complementary strengths of both approaches: Transformers excel at capturing global dependencies through self-attention mechanisms, while SSMs provide efficient sequence processing with O(N) scaling during training and O(1) cache size during inference. Despite their improved efficiency, many hybrid language models, including hybrid large language models (LLMs), remain incredibly large, often spanning billions of parameters. This motivates the need for efficiently creating smaller (i.e. compressing) hybrid language models suitable for deployment in various resource-constrained environments. The present disclosure provides a group-aware pruning strategy for hybrid language models and pretrained neural networks having non-permutation equivariant layers, which can preserve the structural integrity of SSM blocks and their sequence modeling capabilities to achieve improved accuracy and inference speed compared to traditional approaches.

### RELATED APPLICATION(S)

This application claims the benefit of U.S. Provisional Application No. 63/786,832 (Attorney Docket No. NVIDP1439+/25-SC-0450US01), titled “PRUNING AND DISTILLATION OF HYBRID LLMS” and filed Apr. 10, 2025, the entire contents of which is incorporated herein by reference.

### TECHNICAL FIELD

The present disclosure relates to processes for compressing hybrid language models.

### BACKGROUND

Recent advances in language modeling have led to the development of hybrid architectures that combine Transformer layers with State Space Models (SSMs). These hybrid models leverage the complementary strengths of both approaches: Transformers excel at capturing global dependencies through self-attention mechanisms, while SSMs provide efficient sequence processing with O(N) scaling during training and O(1) cache size during inference.

Despite their improved efficiency, many hybrid language models, including hybrid large language models (LLMs), remain incredibly large, often spanning billions of parameters. This motivates the need for efficiently creating smaller (i.e. compressing) hybrid language models suitable for deployment in various resource-constrained environments.

One way to reduce the size of a hybrid language model is by model pruning which refers to the removal of redundant parameters while preserving accuracy. In particular, methods that combine structured pruning (i.e., pruning of entire parameter blocks such as neurons, attention heads, etc.) with knowledge distillation have proven effective at simultaneously reducing model memory footprint while improving runtime performance and accuracy. While pruning techniques have been extensively studied for Transformer architectures, their application to hybrid models remains significantly underexplored.

Some early work on SSM pruning includes removing the entire state space module from the SSM layers, leaving only linear projections and a convolution layer. Other works have proposed a method for pruning SSM architectures by focusing on three aspects: state space dimension reduction, SSM head dimension pruning, and SSM head merging. However, no existing work on SSM pruning presents a holistic compression strategy that simultaneously combines various aspects of SSM pruning with the pruning of other network components such as FFN neurons, embedding channels, and network depth, which in turn limits runtime performance and model accuracy.

There is thus a need for addressing these issues and/or other issues associated with the prior art. For example, there is a need to provide a group-aware pruning strategy for hybrid language models and pretrained neural networks having non-permutation equivariant layers, which can preserve the structural integrity of SSM blocks and their sequence modeling capabilities to achieve improved accuracy and inference speed compared to traditional approaches.

### SUMMARY

A method, computer readable medium, and system are disclosed to compress a pretrained neural network. Group-aware pruning of a non-permutation equivariant layer of a pretrained neural network is performed to generate a compressed neural network. The compressed neural network is output.

### BRIEF DESCRIPTION OF THE DRAWINGS

FIG. 1 illustrates a method for compressing a pretrained neural network, in accordance with an embodiment.

FIG. 2 illustrates a system pipeline for compressing a pretrained neural network, in accordance with an embodiment.

FIG. 3 illustrates an exemplary hybrid language model, in accordance with an embodiment.

FIG. 4 illustrates an implementation of the system pipeline of FIG. 2 for compressing the hybrid language model of FIG. 3, in accordance with an embodiment.

FIG. 5 illustrates a visualization of the non-permutation equivariance of the Mamba layer of FIG. 3 in the context of the system pipeline implementation in FIG. 4, in accordance with an embodiment.

FIG. 6 illustrates an inference time method of a compressed pretrained neural network, in accordance with an embodiment.

FIG. 7A illustrates inference and/or training logic, according to at least one embodiment.

FIG. 7B illustrates inference and/or training logic, according to at least one embodiment.

FIG. 8 illustrates training and deployment of a neural network, according to at least one embodiment.

FIG. 9 illustrates an example data center system, according to at least one embodiment.

### DETAILED DESCRIPTION

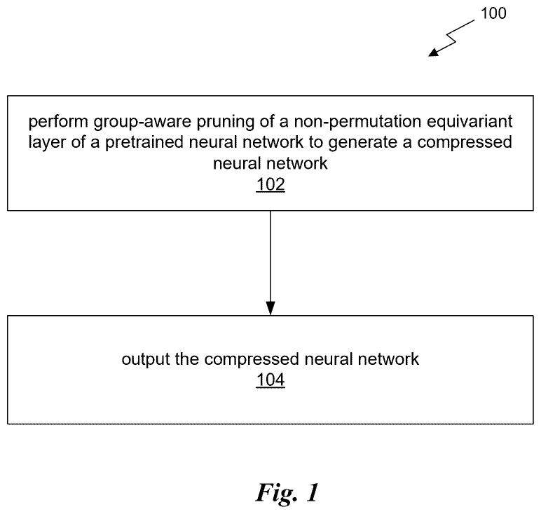

FIG. 1 illustrates a method 100 for compressing a pretrained neural network, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, group-aware pruning of a non-permutation equivariant layer of a pretrained neural network is performed to generate a compressed neural network. The pretrained neural network (also referred to herein as a “model”) is a neural network that includes at least a non-permutation equivariant layer and that has been pretrained to perform at least one task. In an embodiment, the non-permutation equivariant layer may be a state space model (SSM) layer (e.g. a Mamba layer). In an embodiment, the SSM layer may be configured to provide sequence processing with a fixed-size memory.

In an embodiment, the neural network may further include one or more additional layers that are permutation invariant (e.g. Transformer layers). In an embodiment, the one or more additional layers may include at least one attention layer. In an embodiment, the one or more additional layers may include at least one multilayer perceptron (MLP) layer. In an embodiment, the permutation invariant layer may capture global dependencies through a self-attention mechanism.

In an embodiment, the neural network may be configured as a pretrained hybrid large language model (LLM). In this embodiment, the hybrid LLM may include at least one SSM layer, at least one attention layer, and at least one MLP layer. The hybrid LLM may be pretrained for at least one language task (e.g. text generation, text summarization, translation, code generation, question answering, etc.).

As mentioned, group-aware pruning of the non-permutation equivariant layer of the pretrained neural network is performed to generate a compressed neural network. In other words, the group-aware pruning reduces a size and/or complexity of the neural network. Group-aware pruning refers to pruning (e.g. removing) components of the non-permutation equivariant layer by component group. In an embodiment, a component group is comprised of a plurality of neural network components that interact with one another (i.e. via their inputs and outputs). In an embodiment, component groups may be determined from a group structure of the non-permutation equivariant layer of the neural network, where such group structure may be determined based on a group-specific interaction pattern.

In an embodiment, the group-aware pruning may include pruning neurons of the non-permutation equivariant layer by group. For example, each group of neurons of the non-permutation equivariant layer may include neurons that interact with one another. In an embodiment, the neurons may be heads of the non-permutation equivariant layer. In an embodiment, performing group-aware pruning of the non-permutation equivariant layer of the pretrained neural network may include computing activation scores for neurons of the non-permutation equivariant layer, and ranking the neurons of the non-permutation equivariant layer based on the activation scores and a group structure of the non-permutation equivariant layer to generate a ranked list of neurons, where the group-aware pruning is performed based on the ranked list of neurons.

In another embodiment, the group-aware pruning may include pruning neuron channels of the non-permutation equivariant layer. In an embodiment, pruning neuron channels of the non-permutation equivariant layer may include ranking the neuron channels to generate a ranked list of neuron channels, where common channels across the neurons have a shared rank, and where the neuron channels are pruned based on the ranked list of neuron channels. In an embodiment, the neuron channels may be pruned uniformly across all neurons of the non-permutation equivariant layer via the shared ranking.

In yet another embodiment, performing group-aware pruning of the non-permutation equivariant layer of the pretrained neural network may include computing neuron channel activation scores for neuron channels of the non-permutation equivariant layer, ranking the neuron channels based on the neuron channel activation scores to generate a ranked list of neuron channels, determining a subset of the neuron channels to keep based on the ranked list of neuron channels, based on the subset of the neuron channels to keep, computing neuron activation scores for neurons of the non-permutation equivariant layer, ranking the neurons based on the neuron activation scores and a group structure of the neurons to generate a ranked list of neurons, determining a subset of the neurons to keep based on the ranked list of neurons, and pruning matrices of the non-permutation equivariant layer based on the subset of the neuron channels to keep and the subset of the neurons to keep.

In an embodiment, operation 102 may also include pruning the one or more additional layers of the neural network and/or an input embedding to the neural network in combination with performing the group-aware pruning of the non-permutation equivariant layer to generate the compressed neural network. Of course, the pruning of the one or more additional layers of the neural network and/or the input embedding may be performed in an operation (not shown) separate from operation 102 of the method 100. In an embodiment, pruning the one or more additional layers of the neural network may include selectively pruning components (e.g. neurons) of the one or more additional layers, based on a predefined selection criteria. In an embodiment, pruning the embedding input may include selectively pruning one or more dimensions from the embedding input.

In an embodiment, structured pruning may be used for the one or more additional layers and/or the embedding input. Structured pruning may refer to removing blocks of nonzero elements, such as via neuron, attention head, convolutional filter, and/or depth pruning. In an embodiment, the pruning of the one or more additional layers of the neural network and/or the input embedding may involve making an importance estimation of the relevant components and then pruning components based on their importance.

In operation 104, the compressed neural network is output. In an embodiment, outputting the compressed neural network may include storing the compressed neural network in a memory. In an embodiment, outputting the compressed neural network may include deploying the compressed neural network for use in performing inferencing operations.

In an embodiment, the compressed neural network may be output to a downstream task that distills knowledge from the pretrained neural network to the compressed neural network to form a refined compressed neural network. In an embodiment, logit-based distillation is used for continued training of the compressed neural network. In an embodiment, forward Kullback-Leibler divergence (FKLD) loss is used for distilling knowledge from the pretrained neural network to the compressed neural network. In an embodiment, the method 100 may further include deploying the refined compressed neural network (e.g. to an execution environment) for use in performing inferencing operations.

To this end, the method 100, when performed, compresses the neural network by at least using group-aware pruning of the non-permutation equivariant layer of the neural network, optionally in combination with the pruning of other permutation invariant layers of the neural network. The group-aware pruning in particular may preserve the structural integrity of the non-permutation equivariant layer and its sequence modeling capability to achieve improved accuracy and inference speed compared to a non-group-aware pruning approach.

Further embodiments will now be provided in the description of the subsequent figures. It should be noted that the embodiments disclosed herein with reference to the method 100 of FIG. 1 may apply to and/or be used in combination with any of the embodiments of the remaining figures below. As mentioned above, any descriptions herein that reference a LLM may equally apply to other types of machine learning models.

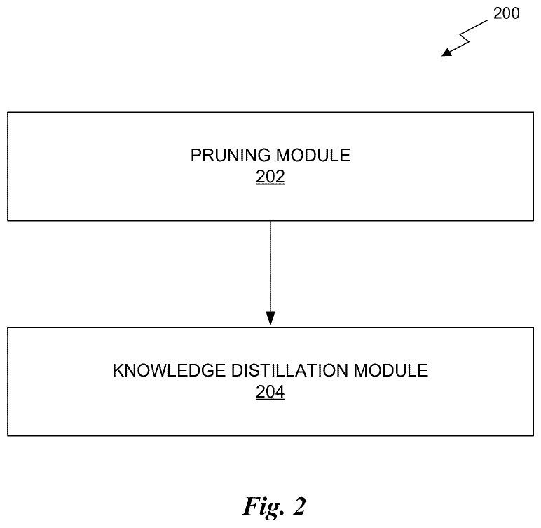

FIG. 2 illustrates a system pipeline 200 for compressing a pretrained neural network, in accordance with an embodiment. The system pipeline 200 may be implemented to carry out the method 100 of FIG. 1, in an embodiment. Thus, the definitions and descriptions provided above may equally apply to the present embodiment.

The modules 202-204 of the system pipeline 200 are configured to perform various functions within a computer system, as described herein. The modules 202-204 may be implemented in hardware, software and/or a combination of hardware and software of the computer system.

The system pipeline 200 includes a pruning module 202 that is configured to prune components of a pretrained neural network to form a compressed neural network. For any non-permutation equivariant layer of the neural network, the pruning module 202 performs group-aware pruning of components of the layer.

In an embodiment, the group-aware pruning may be performed on neurons of the non-permutation equivariant layer of the neural network. In this embodiment, the group-aware pruning may be performed by computing activation scores for the neurons, and ranking the neurons based on the activation scores and a group structure of the non-permutation equivariant layer to generate a ranked list of neurons. In this embodiment, the group-aware pruning may be performed based on the ranked list of neurons. For example, the group-aware pruning may include removing a number of the neurons that are least important to the neural network, as determined based on the ranking.

In an embodiment, the group-aware pruning may be performed on neuron channels of the non-permutation equivariant layer of the neural network. In this embodiment, the group-aware pruning may be performed by ranking the neuron channels to generate a ranked list of neuron channels. In this embodiment, common channels across the neurons of the non-permutation equivariant layer may be assigned a shared rank in the ranked list. In this embodiment, the group-aware pruning may include pruning the neuron channels based on the ranked list. For example, the group-aware pruning may include removing a number of the neuron channels that are least important to the neural network, as determined based on the ranked list. In an embodiment, the neuron channels may be pruned uniformly across all neurons of the non-permutation equivariant layer via the shared ranking.

In another embodiment, the group-aware pruning may be performed on matrices of the non-permutation equivariant layer of the neural network. In this embodiment, the group-aware pruning may be performed by computing neuron channel activation scores for neuron channels of the non-permutation equivariant layer, ranking the neuron channels based on the neuron channel activation scores to generate a ranked list of neuron channels, determining a subset of the neuron channels to keep based on the ranked list of neuron channels, based on the subset of the neuron channels to keep, computing neuron activation scores for neurons of the non-permutation equivariant layer, ranking the neurons based on the neuron activation scores and a group structure of the neurons to generate a ranked list of neurons, and determining a subset of the neurons to keep based on the ranked list of neurons. In this embodiment, the group-aware pruning may include pruning matrices of the non-permutation equivariant layer based on the subset of the neuron channels to keep and the subset of the neurons to keep. For example, neuron channels other than those to keep may be pruned from the neural network and neurons other than the neurons to keep may be pruned from the neural network.

In addition, For any permutation invariant layer of the neural network, the pruning module 202 performs group-independent pruning of components of the layer. In an embodiment, activations and/or weights of the permutation invariant layer may be pruned from the neural network based on predefined pruning criteria.

The output of the pruning module 202 is a compressed neural network. As shown, the system pipeline 200 further includes a knowledge distillation module 204. The knowledge distillation module 204 is configured to distill knowledge from the (non-compressed) pretrained neural network to the compressed neural network to form a refined compressed neural network. In embodiments, the knowledge distillation module 204 may use logit-based distillation for continued training of the compressed neural network or forward Kullback-Leibler divergence (FKLD) loss is for distilling knowledge from the pretrained neural network to the compressed neural network. The output of the knowledge distillation module 204 is the refined compressed neural network.

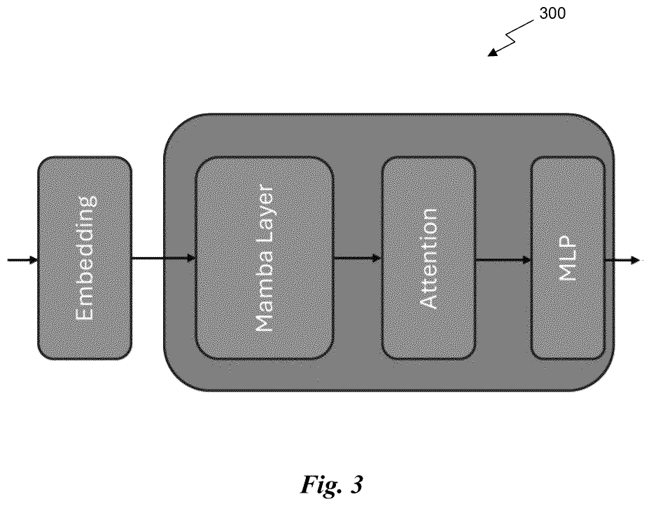

FIG. 3 illustrates an exemplary hybrid language model 300, in accordance with an embodiment. The hybrid language model 300 may be the (non-compressed) pretrained neural network on which the method 100 of FIG. 1 is performed, in an embodiment.

As shown, the hybrid language model 300 includes a Mamba layer (or may include any other SSM layer), an attention layer, and a MLP layer. The Mamba layer processes an input embedding to generate a first intermediate output. The attention layer processes the first intermediate output to generate a second intermediate output, and the MLP layer processes the second intermediate output to generate an output of the hybrid language model 300.

Further embodiments of the Mamba layer (as a more general SSM layer) and the hybrid language model 300 are described below.

State Space Models (SSMs) are a class of sequence models that process inputs through hidden states evolving over time. The general form of an SSM is given by Equations 1 and 2.

hₜ=Ahₜ₋₁+Bxₜ Equation 1

yₜ=C^{T}hₜ+Dxₜ Equation 2

Here, hₜ represents the hidden state, xₜ the input, yₜ the output, and A, B, C, and D are parameter matrices. The above equations describe linear time-invariant (LTI) SSMs, where the parameters remain constant across timesteps. The Mamba architecture introduces a selective SSM variant with time-varying parameters, per Equations 3 and 4.

hₜ=Aₜhₜ₋₁+Bₜxₜ Equation 3

yₜ=Cₜ^{T}hₜ+Dₜxₜ Equation 4

This selective mechanism allows the model to adapt dynamically to the input sequence, improving performance on complex tasks. Mamba2 builds upon the selective SSM framework and introduces several enhancements to improve efficiency and scalability. It leverages the Structured State Space Duality (SSD), which connects SSMs and attention mechanisms through semi-separable matrix representations. This duality enables Mamba2 to combine the linear efficiency of SSMs with hardware-friendly quadratic computations typical of attention models.

SSM-Transformer Hybrid Model architectures combine State Space Models (SSMs) and Transformers to leverage complementary strengths: SSMs enable linear-scaling long-sequence processing, while transformers provide contextual reasoning. These architectures demonstrate three key advantages over pure Transformer architectures: (1) drastically reduced Key-Value (KV) cache requirements enabling memory-efficient long-context processing, and (2) increased throughput via SSM-based sequence modeling. By balancing SSMs' computational efficiency with Transformers' expressivity, hybrid models address critical limitations in pure Transformers approaches for large-scale sequence tasks.

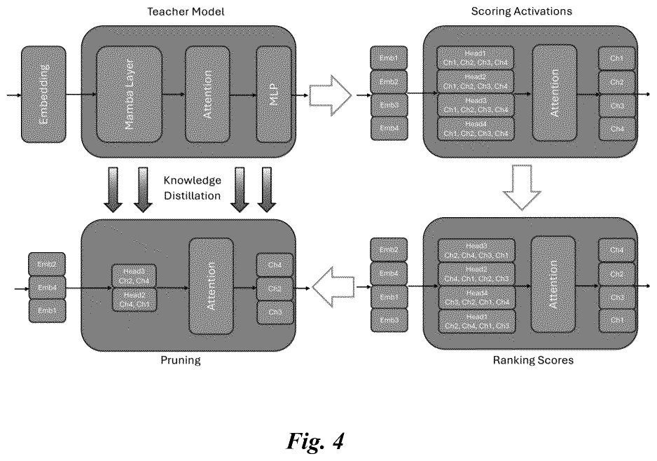

FIG. 4 illustrates an implementation of the system pipeline 200 of FIG. 2 for compressing the hybrid language model 300 of FIG. 3, in accordance with an embodiment.

### Overview

The pruning procedure begins by computing the importance or sensitivity of each network component; namely, Mamba heads and head channels, Feed Forward Neural Network (FFN) neurons, embedding channels, and layers. To keep this phase lightweight, a purely activation-based strategy (requiring only forward propagation passes) may be used for computing importance scores. Once scores are computed, the corresponding network components are sorted in decreasing order of importance while following any additional implementation constraints (discussed in more detail below). The network components with the lowest scores are then pruned from the neural network. Finally, the pruned model is distilled using the teacher model to obtain the final pruned model.

### Mamba Pruning

In a forward pass, the Mamba layer processes input through five distinct projection matrices W_{z}, Wₓ, W_{B}, W_{C}, and W_{d}_{ₜ}, following layer normalization. These projections generate intermediate matrices, per Equations 5-9.

z=W_{z}(LN(X)),W_{z}∈ [symbol] ^{d}^{ₑ}^{×(m}^{ₕ}^{×m}^{_{d}}⁾ Equation 5

x=Wₓ(LN(X)),Wₓ∈ [symbol] ^{d}^{ₑ}^{×(m}^{ₕ}^{×m}^{_{d}}⁾ Equation 6

B=W_{B}(LN(X)),W_{B}∈ [symbol] ^{d}^{ₑ}^{×(g×d}^{ₛ}⁾ Equation 7

C=W_{C}(LN(X)),W_{C}∈ [symbol] ^{d}^{ₑ}^{×(g×d}^{ₛ}⁾ Equation 8

dₜ=W_{d}_{ₜ}(LN(X)),W_{C}∈ [symbol] ^{d}^{ₑ}^{×m}^{ₕ} Equation 9

Where X is the layer input and LN denotes layer normalization. dₑ is model embedding dimension (i.e. hidden dimension), g is the number of Mamba groups, dₛ is the SSM state dimension, mₕ is number of Mamba heads, and m_{d} is Mamba head channels. The matrices x, B, and C undergo causal convolution before participating in the selective SSM updates per Equations 10-13.

\hat{x}=conv1d(x) Equation 10

\hat{B}=conv1d(B) Equation 11

Ĉ=conv1d(C) Equation 12

\tilde{y}=SSM(\hat{x},\hat{B},Ĉ,A,D,dₜ) Equation 13

Here, A, D∈ [symbol] ^{m}^{ₕ} are SSM learnable parameters corresponding to state transition and direct feed through, respectively (see Equations 3 and 4).

The SSM output is fed into a gated normalization layer, which is then followed by output projection, W_{O}∈ [symbol] ^{m}^{ₕ}^{×m}^{_{d}}^{)×d}^{ₑ}, per Equation 14.

y=W_{O}(RMSNorm(\tilde{y},z)) Equation 14

### Group-Aware Head Permutation Constraints

Pruning requires scoring, sorting, and trimming neurons or heads of each layer, as shown in FIG. 4. The FFN and embedding activations are permutation equivariant, i.e. a permutation operator [symbol] , FFN or embedding layer L, and activation [symbol] , and input X results in Equation 15.

L(X)= [symbol] ⇒ [symbol] (L)(X)= [symbol] ( [symbol] ) Equation 15

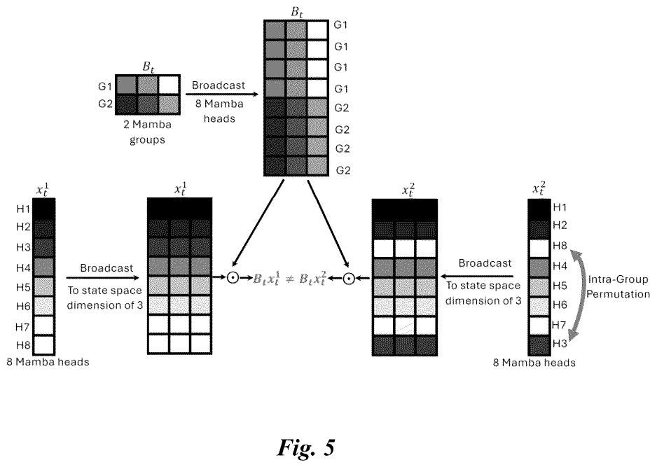

However, Mamba layers and activations are not permutation equivariant. As shown in FIG. 5, the Bₜxₜ operation from Equation 3 involves reshaping B into B∈ [symbol] ^{g×d}^{ₛ}, and broadcasting it across x∈ [symbol] ^{m}^{ₕ}^{×m}^{_{d}}. This broadcasting creates group-specific interaction patterns that constrain the pruning approach. As a result, permuting heads across groups would alter the Bₜxₜ broadcast pattern, violating the group-wise computation of Equation 3 as shown by Equation 16.

Bₜxₜ≠(B [symbol] (xₜ)) [symbol] ^{T} Equation 16

Therefore, when sorting Mamba heads using activation scores, the Mamba's group structure must be preserved. Let [symbol] _{g}⊂{1, . . . , mₕ} denote the set of heads belonging to group g. Any permutation [symbol] of heads must satisfy Equation 17.

[symbol]

(h)∈ [symbol] _{g}∀h∈ [symbol] _{g} Equation 17

In other words, Mamba heads and activations are permutation equivariant only for the permutation operators defined in constraint.

### Head Channel Consistency

A similar constraint for permuting Mamba head channels applies. For head channel pruning, consistency is maintained across all heads through shared ranking. The state tensor h∈ [symbol] ^{m}^{ₕ}^{×m}^{_{d}}^{×d}^{ₛ} requires channel-wise permutations [symbol] _{d} to satisfy Equation 18.

[symbol]

_{d}(h_{i,j,k})= [symbol] _{d}(h_{i′,j,k})∀,i′∈{1, . . . ,mₕ} Equation 18
meaning each channel index k is either preserved or pruned uniformly across all heads.

### Scoring and Ranking Methodology

The Mamba head and head channel ranking follows a nested scoring procedure:
1. Head Channel Scoring: For each head channel d∈{1, . . . , m_{d}}, compute aggregate importance scores, per Equations 19 and 20.

$$s = L N ( X ) {( {W}_{x} )}^{T} \qquad Equation 19$$

$${s}_{d} = {‖ {\sum }_{B , L} {s}_{: , d} ‖}_{2} \qquad Equation 20$$

where the aggregation is over L, the sequence length, and B, the batch size. Aggregation metric used along L and B dimensions are mean and L₂, respectively. s∈ [symbol] ^{(m}^{ₕ}^{×m}^{_{d}}⁾ contains raw activation scores, and s_{:,d} denotes the d-th column across all heads. The top-k_{d} channels are then selected, per Equation 21.

Dₜₒₚ=topk(s_{d},k=k_{d})

d∈{1, . . . ,m_{d}} Equation 21
2. Head Scoring: Using the pruned channels [symbol] ₜₒₚ, compute head importance scores, per Equation 22.

fₕ=∥s_{h,D}_{ₜₒₚ}∥₂∀h∈{1, . . . ,mₕ} Equation 22
3. Group-Constrained Ranking: Within each Mamba group [symbol] _{g}, sort heads by their scores, per Equation 23.

$${R}_{g} = \begin{matrix}arg sort ( {f}_{h} ) \\ h ∈ {𝒢}_{g}\end{matrix} \qquad Equation 23$$

The final head ranking R is the concatenation of group-wise rankings, per Equation 24.

$$R = {⊕}_{g = 1}^{G} {R}_{g} [ 1 : {k}_{g} ]$$

where k_{g} is the target head count per group and ⊕ denotes ordered concatenation.

The following algorithm in Table 1 provides an example for obtaining mamba head and head channel rankings.

TABLE 1
$Require : Activation scores s ∈ {ℝ}^{{m}_{h} \times {m}_{d}} , target channels {k}_{d} , target heads per group {\{ {k}_{g} \}}_{g = 1}^{G}$
{kg} Gg
Ensure: Head ranking R, channel ranking Dₜₒₚ
1: Compute channel scores: s_{d} ← ∥s_{.,d}∥₂ ∀h
2: Dtop ← top-k_{d} indices of {s_{d}}
3: Compute head scores: fₕ = ∥sₕ,_{D}_{ₜₒₚ}∥₂ ∀h
4: for g ← 1 to G do
5: R_{g} ← argsort - descending({fₕ|h ∈ G_{g}})
6: R^{sel} ← first k_{g} elements of R_{g}
7: end for
$8 : R = {⊕}_{g = 1}^{G} {R}_{g}^{sel}$

After obtaining the Mamba heads and head channel neurons to keep, the corresponding matrices are pruned, per Equation 25.

W←W[R], for {Wₓ,W_{z},W_{O},W_{A},W_{D},W_{d}_{ₜ},conv1d} Equation 25

### FFN and Embedding Pruning

For FFN and embedding channels, importance scores are computed using activation-based metrics. Similar to the approach in structured pruning of transformers, the activations produced by the FFN and LayerNorm layers are examined to determine which neurons and embedding channels contribute least to the model's performance.

For the i-th neuron in a feed-forward layer, its importance score is computed per Equation 26.

$${F}_{neuron}^{( i )} = {\sum }_{B , L} {X ( {W}_{1}^{i} )}^{T} \qquad Equation 26$$

where

$${W}_{1}^{i}$$

refers to the i-th row of the weight matrix W₁ in the first linear projection of the FFN, X is the input to the FFN layer, and Σ_{B,L} denotes aggregation along the batch and sequence dimensions.

Similarly, for the i-th embedding channel, its score is computed per Equation 27.

$${F}_{e m b e d}^{( i )} = {\sum }_{B , L} L {N ( X )}_{i} \qquad Equation 27$$

where LN(X)ᵢ represents the i-th dimension of the layer-normalized input. The embedding channel scores are computed across all layers that utilize the embedding channel, including FFN, Mamba and Attention projection layers, and LayerNorm components. Aggregation metric used along L and B dimensions are mean and L₂, respectively, for both embedding Equations.

After computing these scores, they are sorted in descending order and keep the top-k neurons and embedding channels are kept based on the target compression ratio, pruning those with the lowest importance scores.

### Fluctuation-Based Adaptive Structured (FLAP) Importance for Hybrid Models

FLAP is a retraining-free structured pruning technique designed to measure the recoverability of a model's output feature map upon removing specific columns from weight matrices. FLAP quantifies the “fluctuation” of each input feature relative to a baseline using calibration data. Specifically, the FLAP importance score for a column is computed as the product of the squared norm of the column weights and the sample variance of the corresponding input features across calibration samples.

In an embodiment, FLAP is extended to the SSM layers in hybrid architectures by applying the metric to the activations serving as inputs to the output projection (OutProj) matrix. Here, the FLAP importance is computed by assessing the variance in activations input to the OutProj matrix, weighted by the squared norms of the respective columns of the OutProj weights. Mathematically, the extended FLAP importance metric for a given column j of weight matrix W in SSM layers can be defined as Sⱼ=∥Wⱼ∥²·Var(Xⱼ), where ∥Wⱼ∥² denotes the squared norm of the column weights and Var(Xⱼ) represents the variance of the activations input to the output projection matrix of SSM layer across calibration samples.

The above-computed metric is used to rank different heads within each group and remove the corresponding rows in the input projection matrix, the corresponding channels in the SSM convolution kernel, corresponding rows in the A and D matrices of SSM, as well as pruning the corresponding columns in the output projection matrix.

Accuracy Recovery with Knowledge Distillation (KD)

To recover the accuracy lost due to pruning, the model undergoes continued training. In an embodiment, the continued training includes distilling knowledge from the original model to the pruned model. In an embodiment, logit-based distillation may be used for continued training, and forward KL divergence (FKLD) loss may be used exclusively during an accuracy recovery phase.

The output probability distribution of an LLM for a given token xᵢ is computed as

$$p ( {x}_{i} , τ ) = \frac{exp ( \frac{{x}_{i}}{τ} )}{{\sum }_{j = 1}^{\vert V \vert} exp ( \frac{{x}_{j}}{τ} )} ,$$

where τ is the softmax temperature and |V| is the vocabulary size. Logit-based KD loss across the sequence of all output tokens is represented as:

$${L}_{l o g i t s} = \frac{1}{L} {\sum }_{k = 1}^{L} F K L D ( {p}_{t}^{k} ( x , τ ) , {p}_{s}^{k} ( x , τ ) ) ; here , {p}_{t}^{k} ( x , τ ) and {p}_{s}^{k} ( x , τ )$$

represent the teacher and student probability distributions on the kth token, respectively, and L represents the sequence length.

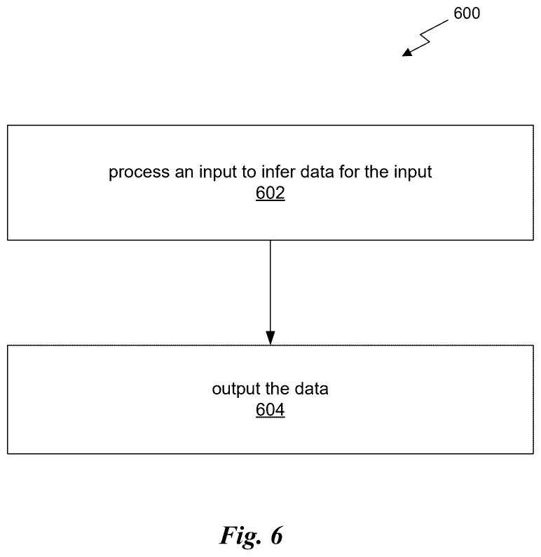

FIG. 6 illustrates an inference time method 600 of a compressed pretrained neural network, in accordance with an embodiment. With respect to the present embodiment, the compressed pretrained neural network is generated by compressing a pretrained neural network in accordance with the method 100 of FIG. 1 and/or the system pipeline 200 of FIG. 2.

In operation 602, an input is processed by the compressed pretrained neural network to infer data for the input. For example, where the compressed pretrained neural network is a compressed hybrid LLM configured to perform a language task, the input may be a command or a question (e.g. provided by a user) and the data inferred by the neural network may be a new text, text summary, translation, etc. created in accordance with the input. In operation 604, the data is output. In an embodiment, the data may be output to a memory. In an embodiment, the data may be output to a display. In an embodiment, the data may be output to a downstream application.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

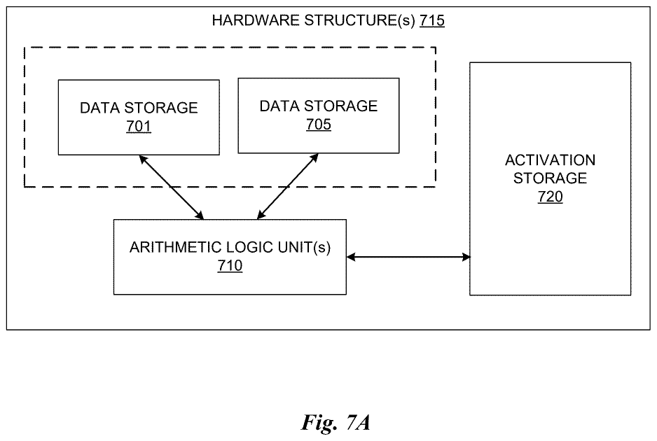

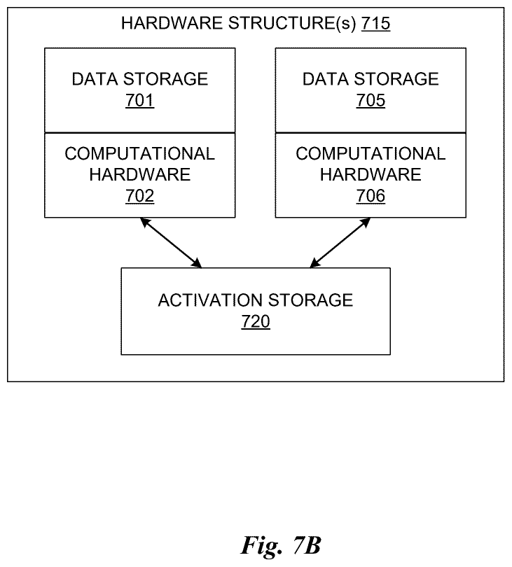

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

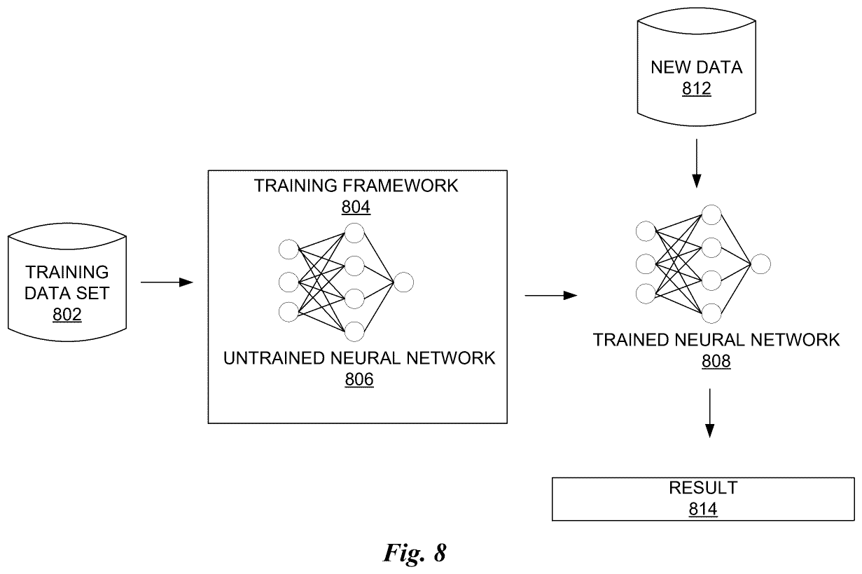

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

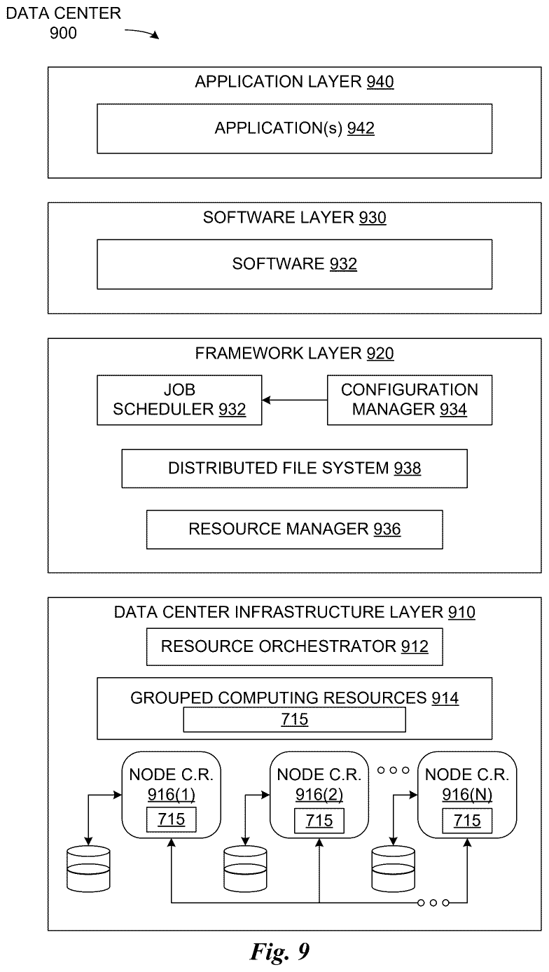

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for compressing a neural network. In accordance with FIGS. 1-6, embodiments may provide such neural network for performing inferencing operations and for providing inferenced data. The neural network may be stored (partially or wholly) in one or both of data storage 701 and 705 in inference and/or training logic 715 as depicted in FIGS. 7A and 7B. Training and deployment of the neural network may be performed as depicted in FIG. 8 and described herein. Distribution of the neural network may be performed using one or more servers in a data center 900 as depicted in FIG. 9 and described herein.

What is claimed is:

1. A method, comprising:
at a device:
performing group-aware pruning of a non-permutation equivariant layer of a pretrained neural network to generate a compressed neural network; and
outputting the compressed neural network.

2. The method of claim 1, wherein the non-permutation equivariant layer includes a state space model (SSM) layer.

3. The method of claim 1, wherein group-aware pruning includes pruning neurons of the non-permutation equivariant layer by group.

4. The method of claim 3, wherein each group of neurons of the non-permutation equivariant layer includes neurons that interact with one another.

5. The method of claim 1, wherein performing group-aware pruning of the non-permutation equivariant layer of the pretrained neural network includes:
computing activation scores for neurons of the non-permutation equivariant layer, and
ranking the neurons of the non-permutation equivariant layer based on the activation scores and a group structure of the non-permutation equivariant layer to generate a ranked list of neurons,
wherein the group-aware pruning is performed based on the ranked list of neurons.

6. The method of claim 5, wherein the neurons are heads of the non-permutation equivariant layer.

7. The method of claim 5, wherein the group structure is determined based on a group-specific interaction pattern.

8. The method of claim 3, wherein group-aware pruning includes pruning neuron channels of the non-permutation equivariant layer.

9. The method of claim 8, wherein pruning neuron channels of the non-permutation equivariant layer includes:
ranking the neuron channels to generate a ranked list of neuron channels,
wherein common channels across the neurons have a shared rank,
wherein the neuron channels are pruned based on the ranked list of neuron channels.

10. The method of claim 9, wherein the neuron channels are pruned uniformly across all neurons of the non-permutation equivariant layer via the shared ranking.

11. The method of claim 1, wherein performing group-aware pruning of the non-permutation equivariant layer of the pretrained neural network includes:
computing neuron channel activation scores for neuron channels of the non-permutation equivariant layer,
ranking the neuron channels based on the neuron channel activation scores to generate a ranked list of neuron channels,
determining a subset of the neuron channels to keep based on the ranked list of neuron channels,
based on the subset of the neuron channels to keep, computing neuron activation scores for neurons of the non-permutation equivariant layer,
ranking the neurons based on the neuron activation scores and a group structure of the neurons to generate a ranked list of neurons,
determining a subset of the neurons to keep based on the ranked list of neurons, and
pruning matrices of the non-permutation equivariant layer based on the subset of the neuron channels to keep and the subset of the neurons to keep.

12. The method of claim 1, wherein the neural network further includes one or more additional layers that are permutation invariant.

13. The method of claim 12, further comprising, at the device:
pruning the one or more additional layers in combination with performing the group-aware pruning of the non-permutation equivariant layer to generate the compressed neural network.

14. The method of claim 12, wherein the one or more additional layers include at least one attention layer.

15. The method of claim 1, wherein the neural network is configured as a pretrained hybrid large language model (LLM).

16. The method of claim 1, wherein outputting the compressed neural network includes:
deploying the compressed neural network for use in performing inferencing operations.

17. The method of claim 1, wherein the compressed neural network is output to a downstream task that distills knowledge from the pretrained neural network to the compressed neural network to form a refined compressed neural network.

18. The method of claim 17, wherein logit-based distillation is used for continued training of the compressed neural network.

19. The method of claim 18, wherein forward Kullback-Leibler divergence (FKLD) loss is used for distilling knowledge from the pretrained neural network to the compressed neural network.

20. The method of claim 17, further comprising, at the device:
deploying the refined compressed neural network for use in performing inferencing operations.

21. A system, comprising:
a non-transitory memory storage comprising instructions; and
one or more processors in communication with the memory, wherein the one or more processors execute the instructions to:
perform group-aware pruning of a non-permutation equivariant layer of a pretrained neural network to generate a compressed neural network; and
output the compressed neural network.

22. The system of claim 21, wherein group-aware pruning includes pruning neurons of the non-permutation equivariant layer by group.

23. The system of claim 22, wherein each group of neurons of the non-permutation equivariant layer includes neurons that interact with one another.

24. The system of claim 21, wherein the neural network is configured as a pretrained hybrid large language model (LLM).

25. The system of claim 21, wherein outputting the compressed neural network includes:
deploying the compressed neural network for use in performing inferencing operations.

26. The system of claim 21, wherein the compressed neural network is output to a downstream task that distills knowledge from the pretrained neural network to the compressed neural network to form a refined compressed neural network.

27. A non-transitory computer-readable media storing computer instructions which when executed by one or more processors of a device cause the device to:
perform group-aware pruning of a non-permutation equivariant layer of a pretrained neural network to generate a compressed neural network; and
output the compressed neural network.

28. The non-transitory computer-readable media of claim 27, wherein group-aware pruning includes pruning neurons of the non-permutation equivariant layer by group.

29. The non-transitory computer-readable media of claim 28, wherein each group of neurons of the non-permutation equivariant layer includes neurons that interact with one another.

30. The non-transitory computer-readable media of claim 27, wherein the neural network is configured as a pretrained hybrid large language model (LLM).

31. The non-transitory computer-readable media of claim 27, wherein outputting the compressed neural network includes:
deploying the compressed neural network for use in performing inferencing operations.

32. The non-transitory computer-readable media of claim 27, wherein the compressed neural network is output to a downstream task that distills knowledge from the pretrained neural network to the compressed neural network to form a refined compressed neural network.
